(19) United States
(12) Patent Application Publication
(10) Pub. No.: US 2023/0110681 A1
(43) Pub. Date: Apr. 13, 2023

(54) COATING MATERIAL OF KILN FOR PRODUCTION OF ACTIVE MATERIAL AND KILN COMPRISING SAME

(71) Applicant: L&F CO., LTD., Daegu (KR)

(72) Inventors: Jun Ho SHIN, Daegu (KR); Sung Kyun CHANG, Daegu (KR); Seung Hwan KIM, Daegu (KR); Jong Wan KIM, Daegu (KR); Ji Woo OH, Daegu (KR); Doe Hyoung KIM, Daegu (KR)

(21) Appl. No.: 17/912,823

(22) PCT Filed: Mar. 11, 2021
(86) PCT No.: PCT/KR2021/003014

§ 371 Date: Sep. 19, 2022

(30) Foreign Application Priority Data
Mar. 31, 2020 (KR) 10-2020-0038829

(51) Int. Cl. F27B 7/28; C04B 35/56; C23C 4/129; C23C 4/06; C23C 4/10

(52) U.S. Cl. CPC F27B 7/28; C04B 35/5626; C23C 4/129; C23C 4/06; C23C 4/10; C04B 2235/3847; C04B 2235/405; C04B 2235/9607; F27D 1/0006

(57) ABSTRACT

Disclosed is a coating material for coating a surface of a kiln for preparing an active material, the coating material being represented by the following Formula 1:

NiₐX_{z} (1)
wherein an equation of a+z=1 is satisfied, with the proviso that 0.2≤a<1.0 and 0<z≤0.8 are satisfied, and X is at least one element selected from the group consisting of W, Cr, Co, Fe, Cu, Na, Al, Mg, Si, Zn, K, Ti, Mo, N, B, P, C, Ta, Nb, O, Mn, Sn, Ag and Zr, or an alloy or compound of two or more elements selected therefrom.

### TECHNICAL FIELD

The present invention relates to a coating material used in kilns for preparing active materials and kilns coated with the coating material.

### BACKGROUND ART

In general, heat treatment is performed using a continuous firing furnace called a “roller hearth kiln (RHK)” in the process of producing a cathode active material. The roller hearth kiln extends lengthwise in the horizontal direction and is divided into several zones, wherein the temperature can be set for each zone and thus the firing temperature is set so as to be gradually elevated or lowered.

When a powdery lithium source was mixed with a metal source and a firing vessel containing the resulting mixture was fed into a roller hearth kiln, continuous firing is performed while the firing vessel moves along the rail. During the firing process, the lithium source reacts with the metal source to produce an active material.

However, the roller hearth kiln has several problems such as poor productivity attributable to the very long firing time due to facility limitations, non-uniform reaction due to lack of fluidity of raw materials, and many spatial restrictions.

Recently, an attempt is being made to produce a cathode active material using a rotary kiln (RK) rather than the roller hearth kiln (RHK).

A rotary kiln is a device for preparing an active material by feeding a lithium source and a metal source into a cylindrical furnace (core tube) disposed at a slight angle and continuously applying external heat thereto while rotating the kiln.

The active material fed into the cylindrical core tube moves little by little toward an outlet located at the opposite end of an inlet as the core tube rotates in an inclined state. The rotation of the core tube enables continuous mixing during the firing process, so that a homogeneous reaction is possible, the production time can be dramatically shortened, and thus production can be maximized.

The core tube of the rotary kiln is generally made of SUS or Inconel. SUS contains Fe as a main component, 28% or less of Ni, 11 to 32% of Cr, and traces of other elements. Inconel contains Ni as a main component, 14 to 15% of Cr, 6 to 7% of Fe, and traces of other elements.

The fired active material undergoes impurity inspection. Since impurities such as Fe and Cr adversely affect the performance of the secondary battery, it is very important to set a reference value for the upper limit of an impurity content and control the impurity content within not more than the reference value.

However, the rotary kiln has several advantages described above, but has a problem in that high amounts of impurities such as Fe and Cr are detected in the prepared active material.

This is considered to be because raw materials such as LiOH, Li₂CO₃, and NCM(OH)₂ used as active material precursors are basic and thus corrosion occurs due to reaction of these materials with the metal material for the core tube at high temperature and in an oxidizing atmosphere, and elements constituting the core tube are desorbed or eluted, thus contaminating the active material, due to various factors such as abrasion of the inner surface while the high-temperature core tube inner wall continuously contacts the active material by rotation.

Incorporation into the active material due to desorption or elution of the impurities not only adversely affects the active material and the secondary battery including the same, but also greatly reduces the lifespan of the core tube.

Accordingly, there is an increasing need for a novel technology capable of solving these problems.

### DISCLOSURE

### Technical Problem

Therefore, the present invention has been made to solve the above and other technical problems that have yet to be solved.

Therefore, as a result of extensive research and various experimentation, the present inventors found that, when the inner wall of kilns for preparing an active material is coated with a coating material of a specific composition, a high-quality active material can be prepared and the lifetime of the kiln can be improved by greatly suppressing the incorporation of impurities derived from the kilns into the active material during firing of the active material. The present invention was completed based thereon.

### Technical Solution

In accordance with an aspect of the present invention, provided is a coating material for coating a surface of a kiln for preparing an active material, the coating material being represented by the following Formula 1:

NiₐX_{z} (1)

wherein

an equation of a+z=1 is satisfied, with the proviso that 0.2≤a<1.0 and 0<z≤0.8 are satisfied; and

X is at least one element selected from the group consisting of W, Cr, Co, Fe, Cu, Na, Al, Mg, Si, Zn, K, Ti, Mo, N, B, P, C, Ta, Nb, O, Mn, Sn, Ag and Zr, or an alloy or compound of two or more elements selected therefrom.

The coating material having such a composition according to the present invention suppresses the incorporation of impurities such as Fe and Cr derived from the kiln into the active material during firing for preparing an active material, thereby enabling preparation of an active material with excellent physical properties, improving the lifetime of the kiln and ultimately reducing the preparation cost of the active material.

As described above, the coating material of the present invention is preferably applied to a kiln formed of a material containing Fe and/or Cr, particularly a rotary kiln, but in some cases, is applicable to various types of kilns not containing Fe and Cr.

In the description of component X in Formula 1, the term “alloy” refers to a combination of elements having a metal bond between metal elements or between a metal element and a non-metal element, and the term “compound” refers to a combination of elements having a covalent bond or the like other than a metal bond between non-metal elements.

Therefore, overall, NiₐX_{z} of Formula 1 may be understood as a nickel alloy containing X as an element, an alloy, or a compound, and preferably, a Ni alloy containing X as an element or an alloy.

In one specific example, the coating material of the present invention may have a composition of the following Formula 2:

NiₐW_{b}Cr_{c}Co_{d}Mₑ (2)

wherein

an equation of a+b+c+d+e=1, with the proviso that 0.2≤a<1.0, 0≤b≤0.8, 0≤c≤0.7, 0≤d≤0.7, and 0≤e≤0.8 are satisfied; and

M is at least one element selected from the group consisting of Fe, Cu, Na, Al, Mg, Si, Zn, K, W, Ti, Mo, N, B, P, C, Ta, Nb, O, Mn, Sn, Ag and Zr, or an alloy or compound of two or more elements selected therefrom.

a, b, c, d, and e may be controlled by various factors such as the component composition of the kiln, the component composition of an active material, and the firing temperature range of the kiln.

In a preferred embodiment, a, b, c, d, and e are mole fractions that satisfy 0.5≤a<1.0, 0≤b≤0.5, 0≤c≤0.2, 0≤d≤0.2, and 0≤e≤0.5, respectively. As can be seen from the experimental results to be described later, a particularly preferred result is obtained when the Ni content is at least 50 mol %, and overall, the effect tends to be improved, as the content thereof increases.

In a more preferred embodiment, a, b, c, d, and e satisfy the following ranges of 0.5≤a<1.0, 0≤b≤0.5, 0≤c≤0.15, 0≤d≤0.15, and 0≤e≤0.2, respectively.

In a particularly preferred embodiment, a, b, c, d, and e satisfy the following ranges of 0.75≤a<0.95, 0.05≤b≤0.3, 0≤c≤0.1, 0≤d≤0.1, and 0≤e≤0.2, respectively.

For example, the alloy or compound may include at least one selected from the group consisting of TiC, SiC, VC, ZrC, NbC, TaC, B₄C, Mo₂C, TiN, BN, Si₃N₄, ZrN, VN, TaN, NbC, NbN, HfN and MoN.

As can be seen from the experimental results to be described later, an alloy based on Ni and WC exhibits a particularly excellent effect as a coating material. Accordingly, the present invention also provides a coating material represented by the following Formula 3:

NiₐWC_{b}Cr_{c}Co_{d}Mₑ (3)

wherein

an equation of a+b+c+d+e=1 is satisfied, with the proviso that 0.2≤a<1.0, 0<b≤0.8, 0≤c≤0.5, 0≤d≤0.5, and 0≤e≤0.5 are satisfied; and

M is at least one element selected from the group consisting of Fe, Cu, Na, Al, Mg, Si, Zn, K, W, Ti, Mo, N, B, P, Ta, Nb, O, Mn, Sn, Ag and Zr, or an alloy or compound of two or more elements selected therefrom.

In a preferred embodiment, a, b, c, d, and e satisfy the ranges of 0.2≤a<1.0, 0.05≤b≤0.8, 0≤c≤0.1, 0≤d≤0.1, and 0≤e≤0.2, respectively. In a more preferred embodiment, a, b, c, d, and e satisfy the ranges of 0.5≤a<1.0, 0.05≤b≤0.5, 0≤c≤0.1, 0≤d≤0.1, and 0≤e≤0.2, respectively.

In another specific embodiment, the coating material of the present invention is a material for coating the surface of a kiln for preparing an active material, wherein the coating material satisfies the following requirement (a), (b) or (c) at a temperature not less than 800° C. and less than 900° C. when ICP-MS analysis is performed on the active material heat-treated under the following conditions,

(a) the content of Fe is less than 517 ppm;

(b) the content of Cr is less than 8,450 ppm, or

(c) both of (a) and (b) are satisfied.

[Conditions]
Specimen type: SUS 310S
Specimen size: 100 mm×100 mm×20 mm (width×length×height)
Coating method: High-velocity oxy-fuel spraying method
Coating material: Ni-containing material
Active material firing: 10 g of a cathode active material is uniformly loaded on the surface of the specimen, the specimen is fed into a kiln, heated in an oxygen atmosphere at a rate of 5° C./min to a temperature of not less than 800° C. and less than 900° C., fired for 8 hours and then cooled slowly to room temperature.

The present invention also provides a kiln for preparing an active material, wherein a coating layer including the coating material described above is formed in a portion of the kiln that contacts the active material. The type of the kiln is not particularly limited and in one specific embodiment, the kiln may be a rotary kiln.

The coating layer may be formed using the coating material of the present invention in the kiln in various ways. In the examples, etc. to be described later, the surface of the specimen is uniformly coated with the coating material using high-velocity oxy-fuel spraying, but this coating is also possible using several spraying methods such as arc spraying, powder spraying, plasma spraying, and cold spraying, as well as various methods such as chemical vapor deposition (CVD), and physical vapor deposition (PVD).

Since the portion of the kiln contacting the active material is, for example, the inner surface of the core tube in the kiln, the coating layer is preferably formed on the inner surface of the core tube.

The inner surface of the core tube may be formed of various materials, for example, an Iconel or SUS-based material.

The thickness of the formed coating layer is not particularly limited as long as the present invention can exert the desired effect, and may be, for example, in the range of 0.1 mm to 2.0 mm. The result of the experiments on the thickness of the coating layer showed that, when the thickness is less than 0.1 mm, the effects of improving durability and reducing impurities are insufficient, and when the thickness is higher than 2.0 mm, the increase in the impurity suppression effect was insufficient and the cost and time for forming the coating layer are inefficiently increased. Therefore, it is preferable to form a coating layer with a thickness of 0.1 mm to 2.0 mm and it is possible to adjust the thickness of the coating layer less than 0.1 mm or more than 2.0 mm depending on the applied situation.

The coating layer prevents the incorporation of impurities into the active material and improves abrasion resistance, corrosion resistance, heat resistance, hardness, and the like in the kiln.

### Effects of the Invention

As described above, the coating material according to the present invention suppresses the incorporation of impurities such as Fe and Cr derived from the kiln into the active material during firing for preparing the active material, thereby providing effects of preparing an active material with excellent physical properties, of improving the lifetime of a kiln, preferably a rotary kiln, based on improvement of the hardness, abrasion resistance, and corrosion resistance of the core tube in the kiln, and of ultimately reducing the cost of preparing the active material.

### BEST MODE

Now, the present invention will be described in more detail with reference to the following examples. These examples should not be construed as limiting the scope of the present invention.

### Comparative Example 1

An SUS 310S specimen, one of the materials for a rotary kiln, was prepared in a size of 100 mm×100 mm×20 mm (width×length×height), 10 g of a cathode active material (Li_{1.03}Ni_{0.70}Co_{0.15}Mn_{0.15}O₂) was uniformly loaded to the entire surface of the specimen, and the resulting specimen was fed into a kiln, heated to a temperature of 600° C. at a rate of 5° C./min in an oxygen atmosphere and was then fired for 8 hours.

When the firing was completed, the specimen was slowly cooled to room temperature, the active material was collected, and ICP-MS (inductively coupled plasma mass spectroscopy) analysis was performed.

10 g of a fresh cathode active material (Li_{1.03}Ni_{0.70}Co_{0.15}Mn_{0.15}O₂) was uniformly loaded on the surface of the specimen, fed into a kiln, heated to a temperature to 675° C. at a rate of 5° C./min in an oxygen atmosphere and then fired for 8 hours.

When the firing was completed, the specimen was cooled to room temperature and was taken out, the active material was collected, and ICP-MS analysis was performed.

This process was repeatedly performed at 600° C., 675° C., 700° C., 725° C., 775° C., 800° C., 825° C., and 900° C.

### Comparative Example 2

Firing and analysis were performed under the same conditions as in Comparative Example 1, except that the type of specimen was changed to an Inconel specimen.

### Example 1

An SUS 310S specimen, one of the materials for a rotary kiln, was prepared in a size of 100 mm×100 mm×20 mm (width×length×height), and the surface of the specimen was uniformly coated with a coating material containing 20 mol % of nickel (Ni) and 80 mol % of tungsten carbide (WC) using high-velocity oxy-fuel spraying. 10 g of a cathode active material (Li_{1.03}Ni_{0.70}Co_{0.15}Mn_{0.15}O₂) was uniformly loaded to the entire surface of the coated specimen, and the resulting specimen was fed into a kiln, heated to a temperature of 600° C. at a rate of 5° C./min in an oxygen atmosphere and was then fired for 8 hours.

When the firing was completed, the specimen was slowly cooled to room temperature, the active material was collected, and ICP-MS (inductively coupled plasma mass spectroscopy) analysis was performed.

10 g of a fresh cathode active material (Li_{1.03}Ni_{0.70}Co_{0.15}Mn_{0.15}O₂) was uniformly loaded on the surface of the specimen, fed into a kiln, heated to a temperature to 675° C. at a rate of 5° C./min in an oxygen atmosphere and then fired for 8 hours.

When the firing was completed, the specimen was cooled to room temperature and was taken out, the active material was collected, and ICP-MS analysis was performed.

This process was repeatedly performed at 600° C., 675° C., 700° C., 725° C., 775° C., 800° C., 825° C., and 900° C.

### Example 2

Firing and analysis were performed under the same conditions as in Example 1, except that the coating material was changed to a material containing 50 mol % of nickel (Ni) and 50 mol % of tungsten carbide (WC).

### Example 3

Firing and analysis were performed under the same conditions as in Example 1, except that the coating material was changed to a material containing 60 mol % of nickel (Ni) and 40 mol % of tungsten carbide (WC).

### Example 4

Firing and analysis were performed under the same conditions as in Example 1, except that the coating material was changed to a material containing 75 mol % of nickel (Ni) and 25 mol % of tungsten carbide (WC).

### Example 5

Firing and analysis were performed under the same conditions as in Example 1, except that the coating material was changed to a material containing 80 mol % of nickel (Ni) and 20 mol % of tungsten carbide (WC).

### Example 6

Firing and analysis were performed under the same conditions as in Example 1, except that the coating material was changed to a material containing 90 mol % of nickel (Ni) and 10 mol % of tungsten carbide (WC).

### Example 7

Firing and analysis were performed under the same conditions as in Example 1, except that the coating material was changed to a material containing 93 mol % of nickel (Ni) and 7 mol % of chromium (Cr).

### Example 8

Firing and analysis were performed under the same conditions as in Example 1, except that the coating material was changed to a material containing 50 mol % of nickel (Ni) and 50 mol % of cobalt (Co).

### Example 9

Firing and analysis were performed under the same conditions as in Example 1, except that the coating material was changed to a material containing 50 mol % of nickel (Ni), 40 mol % of tungsten carbide (WC) and 10 mol % of chromium (Cr).

### Example 10

Firing and analysis were performed under the same conditions as in Example 1, except that the coating material was changed to a material containing 50 mol % of nickel (Ni), 40 mol % of tungsten carbide (WC) and 10 mol % of cobalt (Co).

### Example 11

Firing and analysis were performed under the same conditions as in Example 1, except that the coating material was changed to a material containing 90 mol % of nickel (Ni), 5 mol % of tungsten carbide (WC) and 5 mol % of chromium (Cr).

### Example 12

Firing and analysis were performed under the same conditions as in Example 1, except that the coating material was changed to a material containing 90 mol % of nickel (Ni), 5 mol % of tungsten carbide (WC) and 5 mol % of cobalt (Co).

### Experimental Example 1

The results of the ICP-MS analysis performed in Comparative Examples 1 and 2 and Examples 1 to 12 are shown in Tables 1 and 2 below. Table 1 shows the result of ICP-MS analysis for the Fe content and Table 2 shows the result of ICP-MS analysis for the Cr content.

TABLE 1

| | | Coating | | | | | | | | |
|---|---|---|---|---|---|---|---|---|---|---|
| | Type of | material | Fe (ppm) | | | | | | | |
| Item | sample | (mol) | 600° C. | 675° C. | 700° C. | 725° C. | 775° C. | 800° C. | 825° C. | 900° C. |
| Comparative | SUS310S | — | 0 | 0 | 8 | 66 | 232 | 507 | 953 | 4051 |
| Example 1 | | | | | | | | | | |
| Comparative | Inconel | — | 0 | 0 | 1 | 33 | 81 | 692 | 996 | 2281 |
| Example 2 | | | | | | | | | | |
| Example 1 | SUS310S | Ni0.20 | 0 | 0 | 0 | 14 | 68 | 153 | 430 | 1448 |
| | | WC0.80 | | | | | | | | |
| Example 2 | SUS310S | Ni0.50 | 0 | 0 | 0 | 3 | 5 | 116 | 227 | 346 |
| | | WC0.50 | | | | | | | | |
| Example 3 | SUS310S | Ni0.60 | 0 | 0 | 0 | 1 | 3 | 81 | 125 | 190 |
| | | WC0.40 | | | | | | | | |
| Example 4 | SUS310S | Ni0.75 | 0 | 0 | 0 | 1 | 3 | 48 | 71 | 133 |
| | | WC0.25 | | | | | | | | |
| Example 5 | SUS310S | Ni0.80 | 0 | 0 | 0 | 0 | 0 | 0 | 0 | 2 |
| | | WC0.20 | | | | | | | | |
| Example 6 | SUS310S | Ni0.90 | 0 | 0 | 0 | 0 | 0 | 0 | 5 | 8 |
| | | WC0.10 | | | | | | | | |
| Example 7 | SUS310S | Ni0.93 | 0 | 0 | 0 | 0 | 0 | 19 | 46 | 273 |
| | | Cr0.07 | | | | | | | | |
| Example 8 | SUS310S | Ni0.50 | 0 | 0 | 0 | 3 | 31 | 151 | 280 | 517 |
| | | Co0.50 | | | | | | | | |
| Example 9 | SUS310S | Ni0.50 | 0 | 0 | 0 | 8 | 27 | 132 | 246 | 438 |
| | | WC0.40 | | | | | | | | |
| | | Cr0.10 | | | | | | | | |
| Example 10 | SUS310S | Ni0.50 | 0 | 0 | 0 | 12 | 53 | 144 | 265 | 461 |
| | | WC0.40 | | | | | | | | |
| | | Co0.10 | | | | | | | | |
| Example 11 | SUS310S | Ni0.90 | 0 | 0 | 0 | 0 | 0 | 17 | 41 | 183 |
| | | WC0.05 | | | | | | | | |
| | | Cr0.05 | | | | | | | | |
| Example 12 | SUS310S | Ni0.90 | 0 | 0 | 0 | 0 | 0 | 19 | 45 | 201 |
| | | WC0.05 | | | | | | | | |
| | | Co0.05 | | | | | | | | |

TABLE 2

| | | Coating | | | | | | | | |
|---|---|---|---|---|---|---|---|---|---|---|
| | Type of | material | Cr (ppm) | | | | | | | |
| Item | sample | (mol) | 600° C. | 675° C. | 700° C. | 725° C. | 775° C. | 800° C. | 825° C. | 900° C. |
| Comparative | SUS310S | — | 813 | 952 | 1020 | 3314 | 5101 | 6923 | 8346 | 11760 |
| Example 1 | | | | | | | | | | |
| Comparative | Inconel | — | 498 | 633 | 767 | 1549 | 3015 | 4522 | 7191 | 13260 |
| Example 2 | | | | | | | | | | |
| Example 1 | SUS310S | Ni0.20 | 387 | 511 | 545 | 1251 | 2904 | 4315 | 6248 | 8450 |
| | | WC0.80 | | | | | | | | |
| Example 2 | SUS310S | Ni0.50 | 246 | 402 | 529 | 578 | 1223 | 2206 | 3504 | 4317 |
| | | WC0.50 | | | | | | | | |
| Example 3 | SUS310S | Ni0.60 | 132 | 283 | 338 | 440 | 941 | 1687 | 2570 | 3961 |
| | | WC0.40 | | | | | | | | |
| Example 4 | SUS310S | Ni0.75 | 49 | 70 | 86 | 148 | 179 | 312 | 444 | 3698 |
| | | WC0.25 | | | | | | | | |
| Example 5 | SUS310S | Ni0.80 | 8 | 15 | 24 | 28 | 39 | 58 | 197 | 1435 |
| | | WC0.20 | | | | | | | | |
| Example 6 | SUS310S | Ni0.90 | 13 | 22 | 35 | 41 | 66 | 92 | 289 | 2023 |
| | | WC0.10 | | | | | | | | |
| Example 7 | SUS310S | Ni0.93 | 16 | 31 | 21 | 69 | 80 | 95 | 361 | 3369 |
| | | Cr0.07 | | | | | | | | |
| Example 8 | SUS310S | Ni0.50 | 362 | 530 | 728 | 955 | 1714 | 3484 | 4705 | 5528 |
| | | Co0.50 | | | | | | | | |
| Example 9 | SUS310S | Ni0.50 | 285 | 443 | 642 | 723 | 1488 | 3017 | 3871 | 4825 |
| | | WC0.40 | | | | | | | | |
| | | Cr0.10 | | | | | | | | |
| Example 10 | SUS310S | Ni0.50 | 310 | 456 | 804 | 910 | 1621 | 3262 | 4186 | 5133 |
| | | WC0.40 | | | | | | | | |
| | | Co0.10 | | | | | | | | |
| Example 11 | SUS310S | Ni0.90 | 14 | 25 | 38 | 48 | 69 | 93 | 303 | 3068 |
| | | WC0.05 | | | | | | | | |
| | | Cr0.05 | | | | | | | | |
| Example 12 | SUS310S | Ni0.90 | 16 | 26 | 38 | 55 | 72 | 95 | 325 | 3122 |
| | | WC0.05 | | | | | | | | |
| | | Co0.05 | | | | | | | | |

As the Ni content of the cathode active material increases, the firing temperature decreases. Recently, the demand for a high-Ni cathode active material having a Ni content of 60% or more has increased. The firing temperature of the cathode active material having a high Ni content is less than 900° C., mainly at 850° C. or less. That is, when preparing a cathode active material with a high Ni content using a rotary kiln, the elution of impurities such as Fe and Cr should be suppressed at a temperature of less than 900° C. When preparing a cathode active material with a Ni content of less than 60%, impurity elution should be suppressed even at a temperature of 900° C. or higher.

As shown in Table 1 above, the Fe content of the SUS310S specimen having no coating layer was analyzed as 507 ppm at a firing temperature of 800° C., 953 ppm at a firing temperature of 825° C., and 4051 ppm at a firing temperature of 900° C., and as shown in Table 2, the Cr content of the SUS310S specimen was 6,923 ppm at 800° C., 8,346 ppm at 825° C., and 11,760 ppm at 900° C.

In addition, as shown in Table 1, the Fe content of the Inconel specimen having no coating layer was analyzed as 692 ppm at a firing temperature of 800° C., 996 ppm at a firing temperature of 825° C., and 2,281 ppm at a firing temperature of 900° C., and as shown in Table 2, the Cr content was analyzed at 4,522 ppm at a firing temperature of 800° C., 7,191 ppm at a firing temperature of 825° C., and 13,260 ppm at a firing temperature of 900° C.

These results indicate that, in the rotary kiln having no coating layer, great amounts of Fe and Cr are eluted and incorporated into the cathode active material. In particular, the results indicate that the increase in impurity elution is large within a temperature range of not less than 700° C. and less than 900° C., which is the firing temperature of the cathode active material with high Ni content, and the amount of impurity elution increases rapidly at 900° C. or higher, which is the firing temperature of the cathode active material with a low Ni content.

Meanwhile, the results of analysis of the samples 1 to 12 in which the coating layer according to the present invention is formed on the surface of the kiln showed that the total amount of elution of impurities is overall reduced compared to Comparative Examples 1 and 2 having no coating layer. In particular, it can be seen that, in Examples 2 to 7 and Examples 11 and 12, the amount of eluted impurities is greatly reduced to less than half at 800° C. or higher.

The impurity-inhibiting effect of Examples 3 to 7 to which the coating material containing nickel (Ni) and tungsten carbide (WC) is applied is particularly high, and in particular, the impurity elution-inhibiting effect thereof is excellent at 800° C. or higher when the Ni content is 80 mol % or more.

### Experimental Example 2

As described above, Experimental Example 1 shows the results of ICP-MS analysis of specimens prepared in Comparative Examples and Examples. The analysis is measured based on a specimen with a size of 100 mm×100 mm×20 mm (width×length×height), and the result may be changed because the actual size of the kiln is much larger than this size.

Accordingly, the present inventors conducted simulations under the conditions shown in Table 3 using the following equation, and the results are shown in Tables 4 and 5 below.

The results of simulation are based on the prediction as to how the amount of detected impurities changes when the coating materials of Comparative Examples and Examples are applied to larger specimens and this enables prediction as to what effect the coating material according to the present invention will have when the area in contact with the active material and the amount of the active material are increased for application to the actual rotary kiln.

$$Q ( relative amount of metal impurity ) ∝ \frac{Contact Area * Time}{Sample Mass} = \frac{h * w * t}{a} \qquad [ Equation ]$$

h: transverse length of specimen (mm)
w: longitudinal length of specimen (mm)
t: firing time (hr)
a: amount of active material (g)

The relative amount of metal impurity based on the specimen of the example as described above was 8,000, which was set as a reference value of 1.

TABLE 3

| | Example | Simulation |
|---|---|---|
| h: Transverse length of specimen (mm), | 100 | 500 |
| w: Longitudinal length of specimen (mm), | 100 | 1,000 |
| Number of surfaces contacting active material | 1 | 1 |
| Contact area (mm²) | 10,000 | 500,000 |
| a: Amount of active material (g) | 10 | 100,000 |
| t: firing time (hr) | 8 | 8 |
| Q: Relative amount of metal impurity | 8,000 | 40 |
| Relative value | 1.0 | 0.0050 |
| Fold | 1 | 200 |

As can be seen from Table 3, the result of simulation is a value predicted under the assumption that 100,000 g of the cathode active material was loaded on the surface of a core tube formed of SUS 310S having a size of 500 mm×1000 mm×20 mm (width×length×height) and fired for 8 hours, and the relative amount of metal impurity was obtained as 40. That is, a 200-fold difference occurs compared to the relative amount of the metal impurity of Examples.

Based on these results, when the amounts of detected impurities in Tables 1 and 2 analyzed in Comparative Examples and Examples are divided by the corresponding fold, the amounts of detected impurities when applied to the kiln having the above specifications can be predicted, and the results are shown in Tables 4 and 5 below.

TABLE 4

| | | Coating | | | | | | | | |
|---|---|---|---|---|---|---|---|---|---|---|
| | Type of | material | Fe (ppm) | | | | | | | |
| Item | sample | (mol) | 600° C. | 675° C. | 700° C. | 725° C. | 775° C. | 800° C. | 825° C. | 900° C. |
| Comparative | SUSS10S | — | 0 | 0 | 0 | 0 | 1 | 3 | 5 | 20 |
| Example 1 | | | | | | | | | | |
| Comparative | Inconel | — | 0 | 0 | 0 | 0 | 0 | 3 | 5 | 11 |
| Example 2 | | | | | | | | | | |
| Example 1 | SUS310S | Ni0.20 | 0 | 0 | 0 | 0 | 0 | 1 | 2 | 7 |
| | | WC0.80 | | | | | | | | |
| Example 2 | SUS310S | Ni0.50 | 0 | 0 | 0 | 0 | 0 | 1 | 1 | 2 |
| | | WC0.50 | | | | | | | | |
| Example 3 | SUS310S | Ni0.60 | 0 | 0 | 0 | 0 | 0 | 0 | 1 | 1 |
| | | WC0.40 | | | | | | | | |
| Example 4 | SUS310S | Ni0.75 | 0 | 0 | 0 | 0 | 0 | 0 | 0 | 1 |
| | | WC0.25 | | | | | | | | |
| Example 5 | SUS310S | Ni0.80 | 0 | 0 | 0 | 0 | 0 | 0 | 0 | 0 |
| | | WC0.20 | | | | | | | | |
| Example 6 | SUS310S | Ni0.90 | 0 | 0 | 0 | 0 | 0 | 0 | 0 | 0 |
| | | WC0.10 | | | | | | | | |
| Example 7 | SUS310S | Ni0.93 | 0 | 0 | 0 | 0 | 0 | 0 | 0 | 1 |
| | | Cr0.07 | | | | | | | | |
| Example 8 | SUS310S | Ni0.50 | 0 | 0 | 0 | 0 | 0 | 1 | 1 | 3 |
| | | Co0.50 | | | | | | | | |
| Example 9 | SUS310S | Ni0.50 | 0 | 0 | 0 | 0 | 0 | 1 | 1 | 2 |
| | | WC0.40 | | | | | | | | |
| | | Cr0.10 | | | | | | | | |
| Example 10 | SUS310S | Ni0.50 | 0 | 0 | 0 | 0 | 0 | 1 | 1 | 2 |
| | | WC0.40 | | | | | | | | |
| | | Co0.10 | | | | | | | | |
| Example 11 | SUS310S | Ni0.90 | 0 | 0 | 0 | 0 | 0 | 0 | 0 | 1 |
| | | WC0.05 | | | | | | | | |
| | | Cr0.05 | | | | | | | | |
| Example 12 | SUS310S | Ni0.90 | 0 | 0 | 0 | 0 | 0 | 0 | 0 | 1 |
| | | WC0.05 | | | | | | | | |
| | | Co0.05 | | | | | | | | |

TABLE 5

| | | Coating | | | | | | | | |
|---|---|---|---|---|---|---|---|---|---|---|
| | Type of | material | Cr (ppm) | | | | | | | |
| Item | sample | (mol) | 600° C. | 675° C. | 700° C. | 725° C. | 775° C. | 800° C. | 825° C. | 900° C. |
| Comparative | SUS310S | — | 4 | 5 | 5 | 17 | 26 | 35 | 42 | 59 |
| Example 1 | | | | | | | | | | |
| Comparative | Inconel | — | 2 | 3 | 4 | 8 | 15 | 23 | 36 | 66 |
| Example 2 | | | | | | | | | | |
| Example 1 | SUS310S | Ni0.20 | 2 | 3 | 3 | 6 | 15 | 22 | 31 | 42 |
| | | WC0.80 | | | | | | | | |
| Example 2 | SUS310S | Ni0.50 | 1 | 2 | 3 | 3 | 6 | 11 | 18 | 22 |
| | | WC0.50 | | | | | | | | |
| Example 3 | SUS310S | Ni0.60 | 1 | 1 | 2 | 2 | 5 | 8 | 13 | 20 |
| | | WC0.40 | | | | | | | | |
| Example 4 | SUS310S | Ni0.75 | 0 | 0 | 0 | 1 | 1 | 2 | 2 | 18 |
| | | WC0.25 | | | | | | | | |
| Example 5 | SUS310S | Ni0.80 | 0 | 0 | 0 | 0 | 0 | 0 | 1 | 7 |
| | | WC0.20 | | | | | | | | |
| Example 6 | SUS310S | Ni0.90 | 0 | 0 | 0 | 0 | 0 | 0 | 1 | 10 |
| | | WC0.10 | | | | | | | | |
| Example 7 | SUS310S | Ni0.93 | 0 | 0 | 0 | 0 | 0 | 0 | 2 | 17 |
| | | Cr0.07 | | | | | | | | |
| Example 8 | SUS310S | Ni0.50 | 2 | 3 | 4 | 5 | 9 | 17 | 24 | 28 |
| | | Co0.50 | | | | | | | | |
| Example 9 | SUS310S | Ni0.50 | 1 | 2 | 3 | 4 | 7 | 15 | 19 | 24 |
| | | WC0.40 | | | | | | | | |
| | | Cr0.10 | | | | | | | | |
| Example 10 | SUS310S | Ni0.50 | 2 | 2 | 4 | 5 | 8 | 16 | 21 | 26 |
| | | WC0.40 | | | | | | | | |
| | | Co0.10 | | | | | | | | |
| Example 11 | SUS310S | Ni0.90 | 0 | 0 | 0 | 0 | 0 | 0 | 2 | 15 |
| | | WC0.05 | | | | | | | | |
| | | Cr0.05 | | | | | | | | |
| Example 12 | SUS310S | Ni0.90 | 0 | 0 | 0 | 0 | 0 | 0 | 2 | 16 |
| | | WC0.05 | | | | | | | | |
| | | Co0.05 | | | | | | | | |

As can be seen from Tables 4 and 5, the results of simulation of Examples 1 to 12 are much better than those of Comparative Examples 1 and 2, and in particular, the results of simulation of Examples 2 to 7 and Examples 11 and 12 are excellent.

Although the rotation of the core tube is not considered in the above equation to predict the change in the amount of impurity detected during continuous contact between the active material and the inner surface of the core tube, various simulations are possible if the equation is appropriately changed by calculating the contact area according to the shape of the inner surface of the core tube.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A coating material for coating a surface of a kiln for preparing an active material, the coating material being represented by the following Formula 1:
NiₐX_{z} (1)
wherein
an equation of a+z=1 is satisfied, with the proviso that 0.2≤a<1.0 and 0<z≤0.8 are satisfied; and
X is at least one element selected from the group consisting of W, Cr, Co, Fe, Cu, Na, Al, Mg, Si, Zn, K, Ti, Mo, N, B, P, C, Ta, Nb, O, Mn, Sn, Ag and Zr, or an alloy or compound of two or more elements selected therefrom.

2. A coating material for coating a surface of a kiln for preparing an active material, the coating material being represented by the following Formula 2:
NiₐW_{b}CrₑCo_{d}Mₑ (2)
wherein
an equation of a+b+c+d+e=1 is satisfied, with the proviso that 0.2≤a<1.0, 0≤b≤0.8, 0≤c≤0.7, 0≤d≤0.7, and 0≤e≤0.8 are satisfied; and
M is at least one element selected from the group consisting of Fe, Cu, Na, Al, Mg, Si, Zn, K, W, Ti, Mo, N, B, P, C, Ta, Nb, O, Mn, Sn, Ag and Zr, or an alloy or compound of two or more elements selected therefrom.

3. The coating material according to claim 2, wherein a, b, c, d, and e satisfy 0.5≤a<1.0, 0≤b≤0.5, 0≤c≤0.2, 0≤d≤0.2, and 0≤e≤0.5, respectively.

4. The coating material according to claim 2, wherein a, b, c, d, and e satisfy 0.5≤a<1.0, 0≤b≤0.5, 0≤c≤0.15, 0≤d≤0.15, and 0≤e≤0.2, respectively.

5. The coating material according to claim 2, wherein a, b, c, d, and e satisfy 0.75≤a<0.95, 0.05≤b≤0.3, 0≤c≤0.1, 0≤d≤0.1, and 0≤e≤0.2, respectively.

6. The coating material according to claim 2, wherein the alloy or compound comprises at least one selected from the group consisting of TiC, SiC, VC, ZrC, NbC, TaC, B₄C, Mo₂C, TiN, BN, Si₃N₄, ZrN, VN, TaN, NbC, NbN, HfN and MoN.

7. A coating material for coating a surface of a kiln for preparing an active material, the coating material being an alloy based on Ni and WC, represented by the following Formula 3:
NiₐWC_{b}CrₑCo_{d}Mₑ (3)
wherein
an equation of a+b+c+d+e=1 is satisfied, with the proviso that 0.2≤a<1.0, 0<b≤0.8, 0≤c≤0.5, 0≤d≤0.5, and 0≤e≤0.5 are satisfied; and
M is at least one element selected from the group consisting of Fe, Cu, Na, Al, Mg, Si, Zn, K, W, Ti, Mo, N, B, P, Ta, Nb, 0, Mn, Sn, Ag and Zr, or an alloy or compound of two or more elements selected therefrom.

8. The coating material according to claim 7, wherein a, b, c, d, and e satisfy 0.2≤a<1.0, 0.05≤b≤0.8, 0≤c≤0.1, 0≤d≤0.1, and 0≤e≤0.2, respectively.

9. The coating material according to claim 7, wherein a, b, c, d, and e satisfy 0.5≤a<1.0, 0.05≤b≤0.5, 0≤c≤0.1, 0≤d≤0.1, and 0≤e≤0.2, respectively.

10. A coating material for coating a surface of a kiln for preparing an active material,
wherein the coating material satisfies the following requirement (a), (b) or (c) at a temperature not less than 800° C. and less than 900° C. when ICP-MS analysis is performed on the active material heat-treated under the following conditions,
(a) the content of Fe is less than 517 ppm;
(b) the content of Cr is less than 8450 ppm, or
(c) both of (a) and (b) are satisfied.
[Conditions]
Specimen type: SUS 310S
Specimen size: 100 mm×100 mm×20 mm (width×length×height)
Coating method: High-velocity oxy-fuel spraying method
Coating material: Ni-containing material
Active material firing: 10 g of a cathode active material is uniformly loaded on the surface of the specimen, the specimen is fed into a kiln, heated in an oxygen atmosphere at a rate of 5° C./min to a temperature of not less than 800° C. and less than 900° C., fired for 8 hours and then cooled slowly to room temperature.

11. A kiln in which a coating layer comprising the coating material according to claim 1 is formed in a portion of the kiln contacting an active material.

12. The kiln according to claim 11, wherein the coating layer is formed on an inner surface of a core tube.

13. The kiln according to claim 11, wherein the coating layer has a thickness of 0.1 mm to 2.0 mm.

14. The kiln according to claim 12, wherein the inner surface of the core tube comprises an Iconel or SUS-based material.
